(19) United States
(12) Patent Application Publication
(10) Pub. No.: US 2018/0270113 A1
(43) Pub. Date: Sep. 20, 2018

(54) INTELLIGENT SFC (ISFC) - COGNITIVE POLICY INSTANTIATION IN SFC ENVIRONMENTS

(71) Applicant: Cisco Technology, Inc., San Jose, CA (US)

(72) Inventors: Nagendra Kumar Nainar, Morrisville, NC (US); Carlos M. Pignataro, Raleigh, NC (US); Rajiv Asati, Morrisville, NC (US); Roque Gagliano, Lausanne (CH)

(21) Appl. No.: 15/460,391

(22) Filed: Mar. 16, 2017

(51) Int. Cl. H04L 12/24; H04L 12/851; H04L 12/26

(52) U.S. Cl. CPC H04L 41/0813; H04L 41/145; H04L 43/0876; H04L 47/2425; H04L 47/2483

(57) ABSTRACT

In one embodiment, a device in a network receives traffic sent via a service function chain (SFC). The device models one or more behavioral characteristics of the traffic using a machine learning-based service function in the SFC. The device causes a change to the SFC based on the modeled one or more behavioral characteristics of the traffic.

### TECHNICAL FIELD

The present disclosure relates generally to computer networks, and, more particularly, to cognitive policy instantiation in Service Function Chaining (SFC) environments.

### BACKGROUND

Network Function Virtualization (NFV) is becoming a key driver and architecture in many large networks for both service providers and enterprises. Generally, NFV entails virtualizing certain network functions that would traditionally be implemented as separate network appliances. For example, NFV may virtualize the functions of firewalls, accelerators, intrusion detection and/or prevention devices, load balances, or the like.

NFV implementations often employ Service Function Chains (SFCs), to control which functions/services are applied to network traffic. For example, a particular SFC may dictate that traffic should be sent through a firewall service function, then through a network address translation (NAT) service function, and finally through a load balancer service function, before being sent on to its destination.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIGS. 3A-3B illustrates an example of a service function chain (SFC) being configured;

FIGS. 4A-4D illustrate examples of service function paths (SFPs) being used to convey traffic;

FIGS. 5A-5E illustrate examples of using a machine learning-based service function to adjust an SFC;

FIG. 6 illustrates an example flow diagram for assessing behavioral characteristics of SFC traffic;

FIG. 7 illustrates an example simplified procedure for causing a change to an SFC based on a modeled behavioral characteristic of SFC traffic; and

FIG. 8 illustrates an example simplified procedure for implementing a change to an SFC.

### DESCRIPTION OF EXAMPLE EMBODIMENTS

### Overview

According to one or more embodiments of the disclosure, a device in a network receives traffic sent via a service function chain (SFC). The device models one or more behavioral characteristics of the traffic using a machine learning-based service function in the SFC. The device causes a change to the SFC based on the modeled one or more behavioral characteristics of the traffic.

In further embodiments, a supervisory device of a service function chain (SFC) in a network receives data indicative of one or more behavioral characteristics of traffic in the SFC from a machine learning-based service function in the SFC that analyzes the traffic. The supervisory device determines a change to the SFC based on the received data indicative of the one or more behavioral characteristics of the traffic in the SFC. The supervisory device sends an instruction to one or more devices of the SFC to implement the determined change to the SFC.

### Description

A computer network is a geographically distributed collection of nodes interconnected by communication links and segments for transporting data between end nodes, such as personal computers and workstations. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

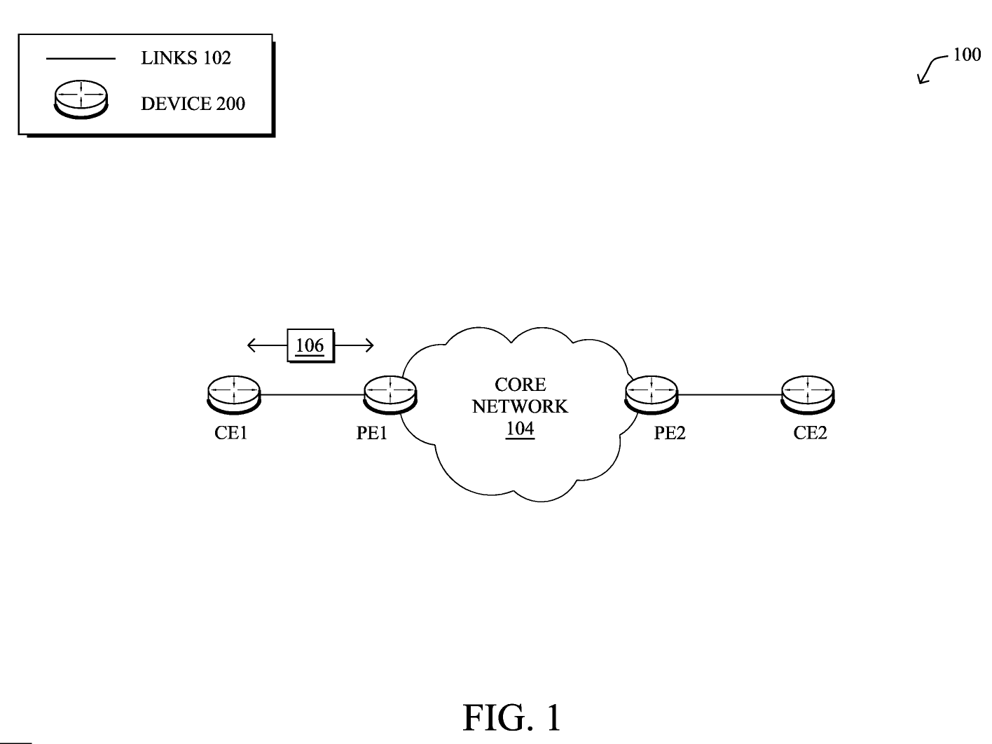

FIG. 1 is a schematic block diagram of an example computer network 100 illustratively comprising nodes/devices 200, such as a plurality of routers/devices interconnected by links or networks, as shown. For example, customer edge (CE) routers (e.g., CE1 and CE2) may be interconnected with provider edge (PE) routers (e.g., PE1 and PE2, respectively), to communicate across a core network, such as an illustrative core network 104. Core network 104 may be a Multi-Protocol Label Switching (MPLS) network or, alternatively, any other form of network (e.g., Internet-based, etc.).

Data packets 106 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

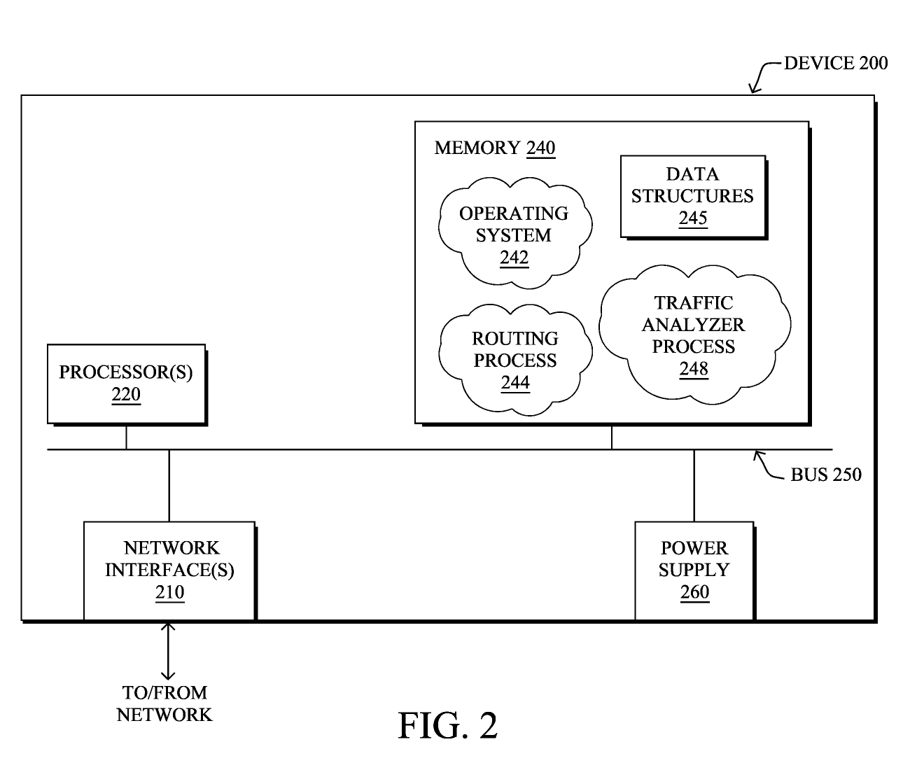

FIG. 2 is a schematic block diagram of an example node/device 200 that may be used with one or more embodiments described herein, e.g., as any of the routers of network 100, or any other computing device that supports the operations of network 100 (e.g., switches, servers, etc.). Device 200 comprises a plurality of network interfaces 210, one or more processors 220, and a memory 240 interconnected by a system bus 250. The network interfaces 210 contain the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processes and/or services executing on the device. These software processes and/or services may include a routing process 244 and/or a traffic analyzer process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Traffic analyzer process 248 includes computer executable instructions that, when executed by processor(s) 220, cause device 200 to model the behavioral patterns associated with traffic in the network. For example, traffic analyzer process 248 may operate in conjunction with routing process 244, to assess traffic flows, events, etc. for potential routing or packet header changes that could be made.

According to various embodiments, traffic analyzer process 248 may employ any number of machine learning techniques, to assess control plane information. In general, machine learning is concerned with the design and the development of techniques that receive empirical data as input (e.g., control plane packet data regarding control plane packets in the network) and recognize complex patterns in the input data. For example, some machine learning techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a,b,c such that the number of misclassified points is minimal. After this optimization/learning phase, traffic analyzer process 248 can use the model M to classify new data points, such as information regarding new control plane traffic in the network. Often, M is a statistical model, and the cost function is inversely proportional to the likelihood of M, given the input data.

In various embodiments, traffic analyzer process 248 may employ one or more supervised, unsupervised, or semi-supervised machine learning models. Generally, supervised learning entails the use of a training dataset, which is used to train the model to apply labels to the input data. For example, the training data may include sample traffic that is labeled “stable” or “unstable,” “suspect” or “benign,” etc. On the other end of the spectrum are unsupervised techniques that do not require a training set of labels. Notably, while a supervised learning model may look for previously seen patterns that have been labeled as such, an unsupervised model may instead look to whether there are sudden changes in the expected behavior of the traffic. Semi-supervised learning models take a middle ground approach that uses a greatly reduced set of labeled training data.

Example machine learning techniques that traffic analyzer process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, autoregressive integrated moving average (ARIMA) models, other time series models, or the like.

The performance of a machine learning model can be evaluated in a number of ways based on the number of true positives, false positives, true negatives, and/or false negatives of the model. For example, the false positives of the model may refer to the number of times the model incorrectly predicted an unstable traffic behavior. Conversely, the false negatives of the model may refer to the times the model incorrectly predicted stability, when the traffic was actually unstable. True negatives and positives may refer to the times that the model correctly classifies the traffic one way or another. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

In some embodiments, traffic analyzer process 248 may analyze packet header information captured from packets of a given traffic flow. For example, traffic analyzer process 248 may capture the source address and/or port of a source node, the destination address and/or port of destination node, the protocol(s) used by the packet, or other header information by analyzing the header of the packet. Example captured features may include, but are not limited to, Transport Layer Security (TLS) information (e.g., from a TLS handshake), such as the ciphersuite offered, user agent, TLS extensions, etc., HTTP information (e.g., URI, etc.), Domain Name System (DNS) information, or any other data features that can be extracted from the observed traffic flow(s).

In further embodiments, traffic analyzer process 248 may also assess the payload of the packet to capture information about the traffic flow. For example, traffic analyzer process 248, or another process in communication therewith, may perform deep packet inspection (DPI) on one or more of the packets, to assess the contents of the packet. Doing so may, for example, yield additional information that can be used to model the traffic flow(s).

Traffic analyzer process 248 data may also compute any number of statistics or metrics regarding the traffic flow. For example, traffic analyzer process 248 may determine the start time, end time, duration, packet size(s), the distribution of bytes within a flow, etc., associated with the traffic flow by observing the packets of the flow. In further examples, the capturing device may capture sequence of packet lengths and time (SPLT) data regarding the traffic flow, sequence of application lengths and time (SALT) data regarding the traffic flow, or byte distribution (BD) data regarding the traffic flow.

Routing process/services 244 contain computer executable instructions executed by processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP) (e.g., in conjunction with process 248), etc., as will be understood by those skilled in the art. These functions may be configured to manage a forwarding information database containing, e.g., data used to make forwarding decisions. In particular, changes in the network topology may be communicated among routers 200 using routing protocols, such as the conventional OSPF and IS-IS link-state protocols (e.g., to “converge” to an identical view of the network topology).

In further embodiments, routing process 244 may be operable to implement the Service Function Chaining (SFC) architecture. For example, details regarding such an architecture can be found in the Internet Engineering Task Force (IETF) request for comments (RFC) 7665 entitled, “Service Function Chaining (SFC) Architecture” by J. Halpern et al., which is hereby incorporated by reference. In general, SFC facilitates the use of network services and provides for network location techniques to locate the device(s) that support these services. Example services may include, but are not limited to, caching services, firewall services, anti-intrusion services, malware detection services, deep packet inspection (DPI) services, acceleration services, load balancing services, lawful intercept (LI) services, optimization services, etc. In particular, a service function chain comprises an ordered set of services that may be provided to network traffic based on the classification of the traffic.

As part of the SFC architecture, a service function path (SFP) may be defined that indicates to which service functions a certain packet must be sent (e.g., which services are to perform their respective functions on the packet). The packet/frame may then be encapsulated, to include an indication of the specific SFP. Of note is that SFC encapsulation is used solely to include data plane context information and is not used for purposes of network packet forwarding. In particular, a network service header (NSH) may be added to a packet or frame, to convey metadata and service path information that may be used to create the service plane. For transport, the NSH and packet may be encapsulated in an outer header. Details regarding an NSH protocol header can be found in the IETF draft entitled, “Network Service Header,” by P. Quinn et al., the contents of which are hereby incorporated by reference.

For a given SFC, there can be a variable number of SFPs and a variable number of Rendered Service Paths (RSPs). Related to the concept of an SFP, an RSP refers to the actual points in the network to which a packet travels. In some cases, an SFP may be constrained to such a degree that the SFP also identifies the actual locations. However, in many cases, an SFP is less constrained, as a service chain can exist as a group of abstract functions/services. Each of the SFPs/RSPs may include a number of specific instances of service functions, service function forwarders (SFFs), and/or proxies. For example, an RSP may comprise the following chain: Firewall_A—NAT_C—Load_Balancer G.

As noted above, the NSH architecture provides the mechanisms for the construction of service chains in a network and the forwarding of traffic through those service chains using network service headers carried within the data plane. The network service headers are imposed on to the original packet/frame through classification. An outer encapsulation used for transport between individual services of the service chain is then pushed on to the packet/frame. Forwarding of packets/frames is achieved at the service plane layer using the NSH headers. Specifically, a Service Path Identifier (SPI) and Service Index (SI) are used for this purpose. A unique SPI is used to identify a given service path instantiation of a service chain, and the SI is initialized to the total number of services within the service chain, and decremented at each service hop as packets/frames traverse through the service path.

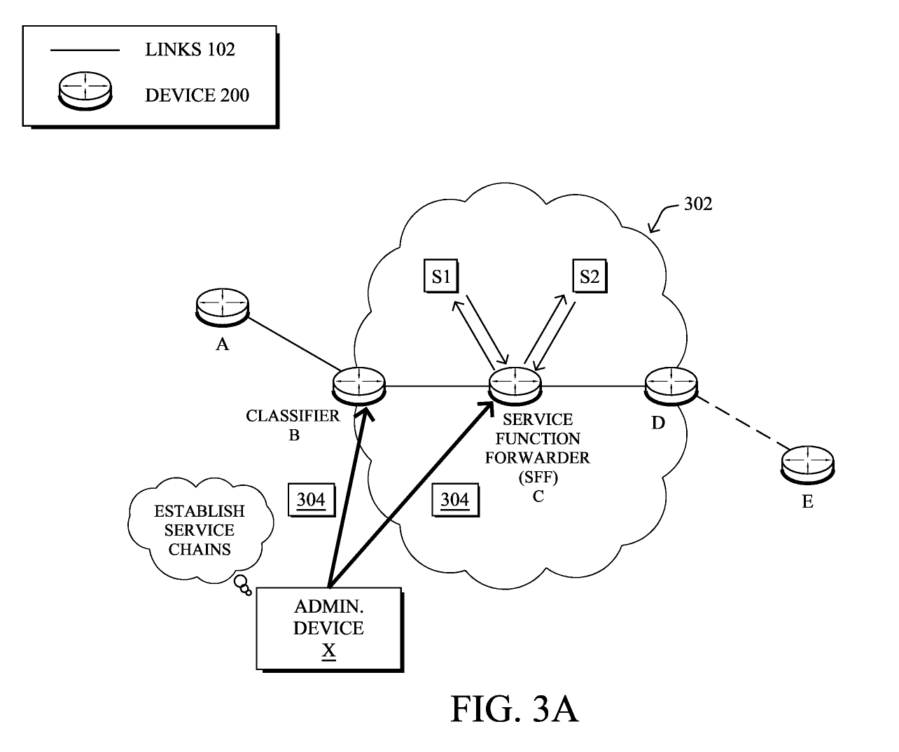

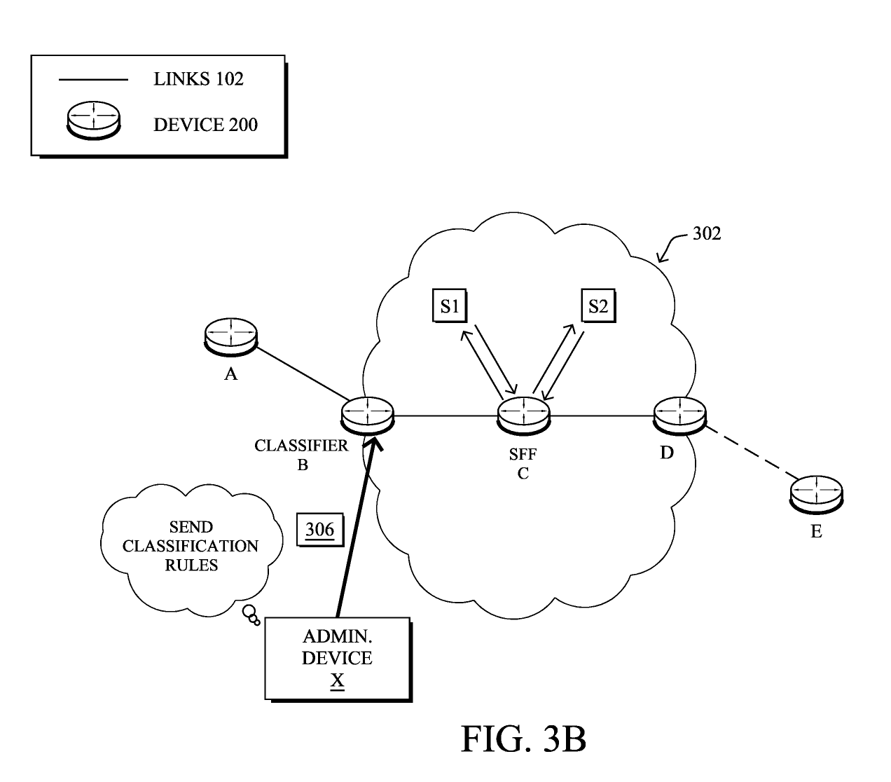

An example of an SFC being configured is shown in FIGS. 3A-3B. As shown in FIG. 3A, assume that nodes A-E exist along a path that traverses network portion 302. In particular, assume that node A is to send traffic to node E via the path shown. Further, assume that node B is an SFC classifier and that node C is an SFF that is configured to forward packets to a number of service functions, S1 and S2. For example, S1 may be a content filtering service and S2 may be a NAT service. In some cases, S1 and S2 may be provided by separate network devices. However, as service functions in an SFC can be virtualized, service functions S1 and S2 can also be implemented locally on node C, in other implementations. As would be appreciated, the nodes shown are presented in a simplified manner and the path between nodes A and E may comprise any number of intermediary nodes and service functions.

An administrator operating an administrative device/node X (e.g., a supervisory device) may define the service chains by sending instructions 304 to the devices/nodes associated with the chain. In some embodiments, the established service paths may be represented by their corresponding SPI and SI, to differentiate the different service paths. For example, one SFP may include service function S1, another SFP may include service function S2, a third SFP may include both service functions S1 and S2, etc. In various embodiments, Open Daylight (ODL), or another similar mechanism, may be used to configure an SFP.

As shown in FIG. 3B, classifier node B may also be programmed with classification rules 306 that are used by classifier node B to make SFC decisions based on the different types of user traffic that may be sent via node B. For example, one classification rule may require only HTTP traffic to pass through content filtering service function S1, whereas other types of traffic may not require this service. Similar to the SFP configurations, the administrator operating administrative device X may define classification rules 306 that are then sent to classifier node B.

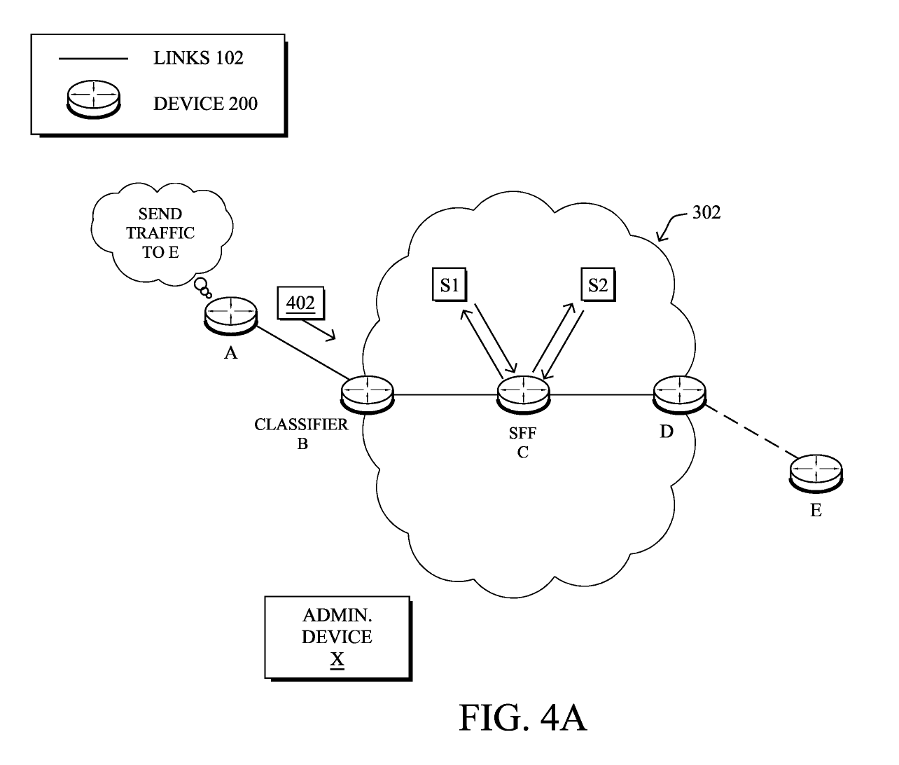

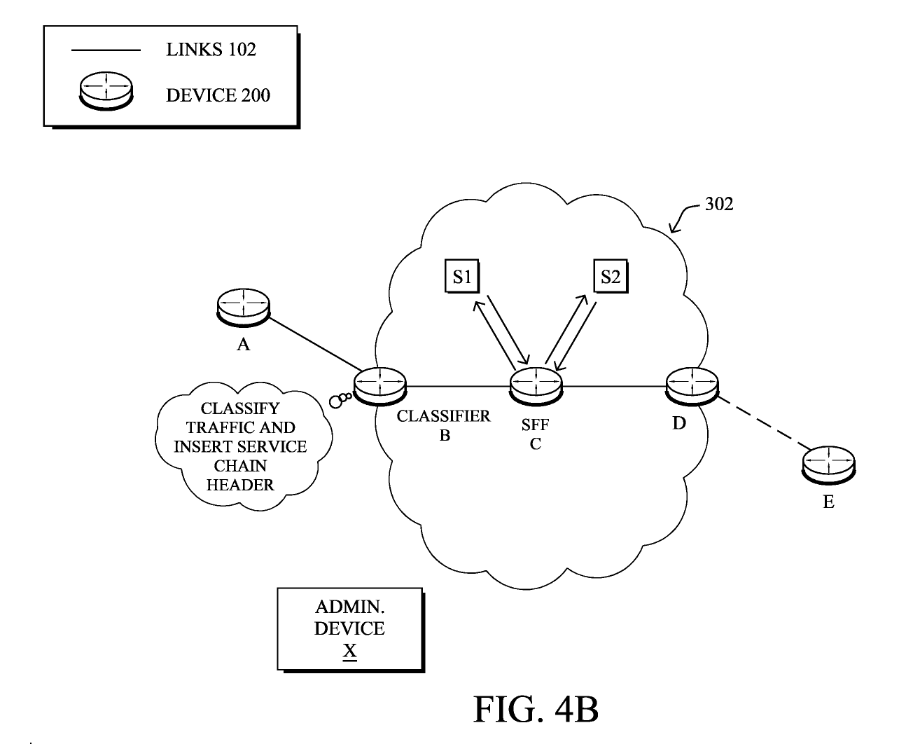

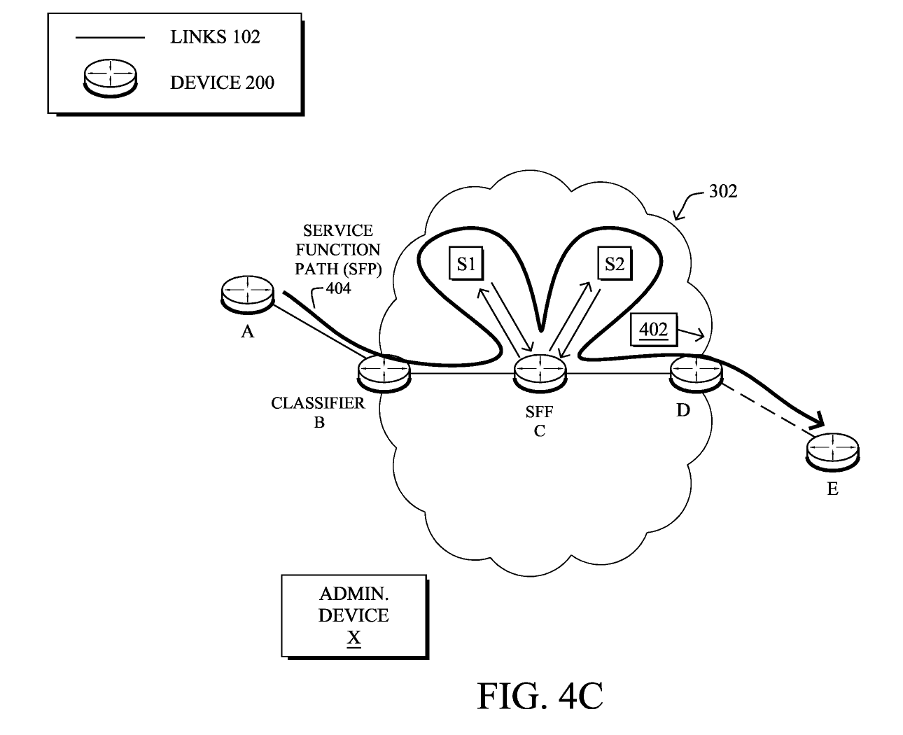

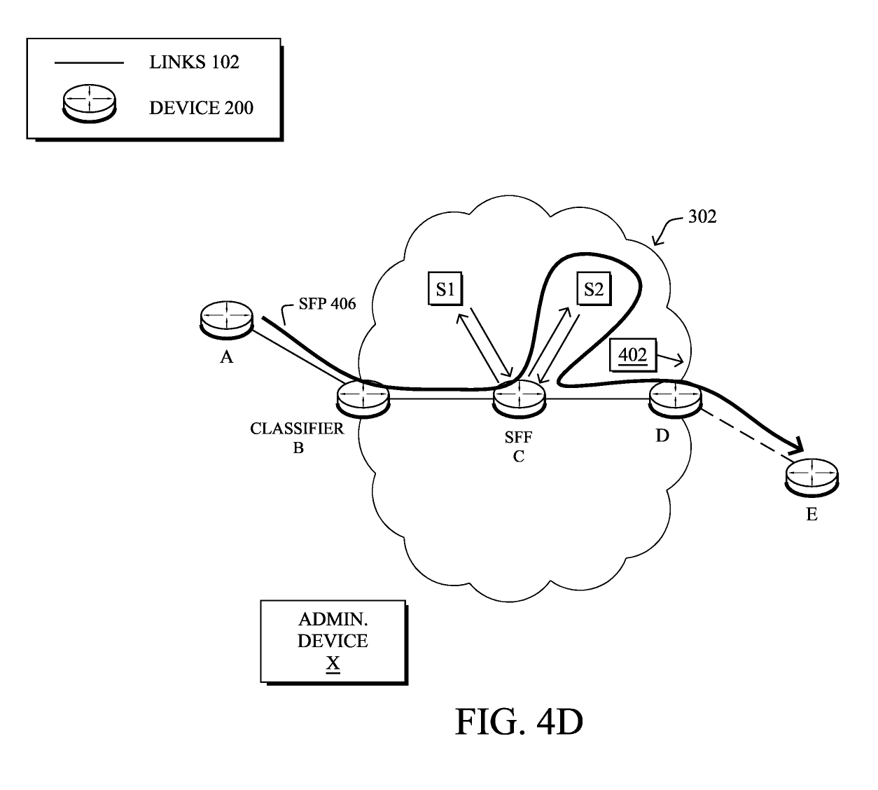

Referring now to FIGS. 4A-4D, examples of SFPs are shown. In FIG. 4A, assume that the SFPs have been established (e.g., as shown in FIGS. 3A-3B) and that node A sends user traffic 402 to node E via classifier node B. In such a case, any number of service functions (e.g., services functions S1, S2, etc.) may be performed on traffic 402, prior to delivery to its destination node E.

As shown in FIG. 4B, classifier node B may classify traffic 402 according to its programmed classification rules (e.g., rules 306). For example, classifier node B may classify traffic 402 by its type (e.g., the application associated with the traffic, etc.), its address information (e.g., the address and/or port of the source and/or destination device), or any other information that may be used to select a particular SFP for the traffic. Based on the classification, classifier node B may then construct a service chain header and encapsulate traffic 402 using the header. For example, classifier node B may select the SPI and SI associated with the classification and, in turn, may construct an NSH header for traffic 402 that indicates the selected values.

A first SFP 404 that may be selected by classifier B for traffic 402 is shown in FIG. 4C. In particular, the NSH header added to traffic 402 may indicate that traffic 402 should be sent to both service functions S1 and S2 for processing. Notably, in response to receiving an NSH-encapsulated packet, SFF C may determine that traffic 402 should be sent first to service function S1 for processing, then on to service function S2, before being forwarded towards its intended destination, node E.

As shown in FIG. 4D, traffic 402 may traverse an alternate SFP 406, based on the NSH header inserted into traffic 402. For example, while SFP 404 includes both service functions S1 and S2, SFP 406 instead only includes service function S2. Thus, the classification of traffic 402 may affect which SFP, if any, the traffic will traverse before delivery to its destination.

As would be appreciated, typical Service Function Chaining (SFC) implementations are fairly static in nature. Notably, an operator may use ODL, or a similar mechanism, to manually define the flow and chain policies, as well as instantiate the state entries on the relevant controls and SFFs. Even when using a group based policy (GBP) is used, the SFC definition is still not completely dynamic. Additionally, even after defining and implementing the initial definitions, subsequent changes will further require intervention by the operator, be it to make a policy change or to make changes to the chains themselves.

Intelligent SFC (ISFC)—Cognitive Policy Instantiation in SFC Environments

The techniques herein leverage machine learning to model the behavioral patterns of traffic within an SFC environment, to automatically adapt the SFC environment, accordingly. In some aspects, a machine learning agent can be implemented as a Service Function (SF) along a given SFC/SFP, to provide observations about the behavior of the traffic to the controller (e.g., ODL, etc.). In turn, this information can be used to determine and implement a dynamic policy for the SFC environment (e.g., by altering which SFs process the traffic, etc.).

Specifically, according to one or more embodiments of the disclosure as described in detail below, a device in a network receives traffic sent via a service function chain (SFC). The device models one or more behavioral characteristics of the traffic using a machine learning-based service function in the SFC. The device causes a change to the SFC based on the modeled one or more behavioral characteristics of the traffic.

In further embodiments, a supervisory device of a service function chain (SFC) in a network receives data indicative of one or more behavioral characteristics of traffic in the SFC from a machine learning-based service function in the SFC that analyzes the traffic. The supervisory device determines a change to the SFC based on the received data indicative of the one or more behavioral characteristics of the traffic in the SFC. The supervisory device sends an instruction to one or more devices of the SFC to implement the determined change to the SFC.

Illustratively, the techniques described herein may be performed by hardware, software, and/or firmware, such as in accordance with the traffic analyzer process 248, which may include computer executable instructions executed by the processor 220 (or independent processor of interfaces 210) to perform functions relating to the techniques described herein, e.g., in conjunction with routing process 244.

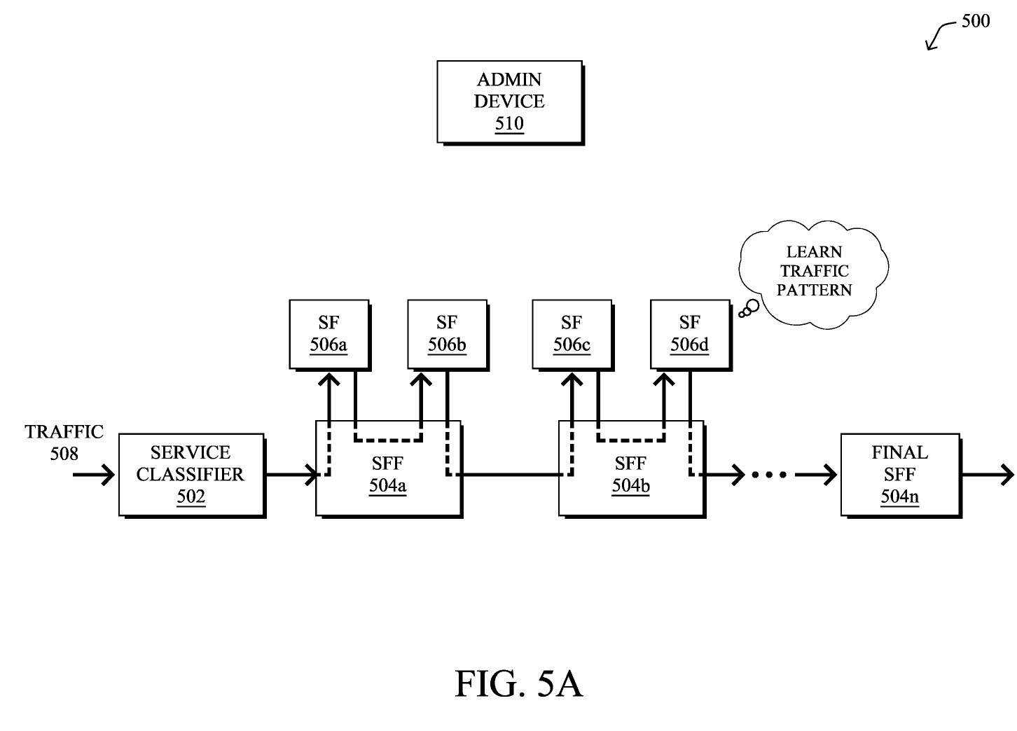

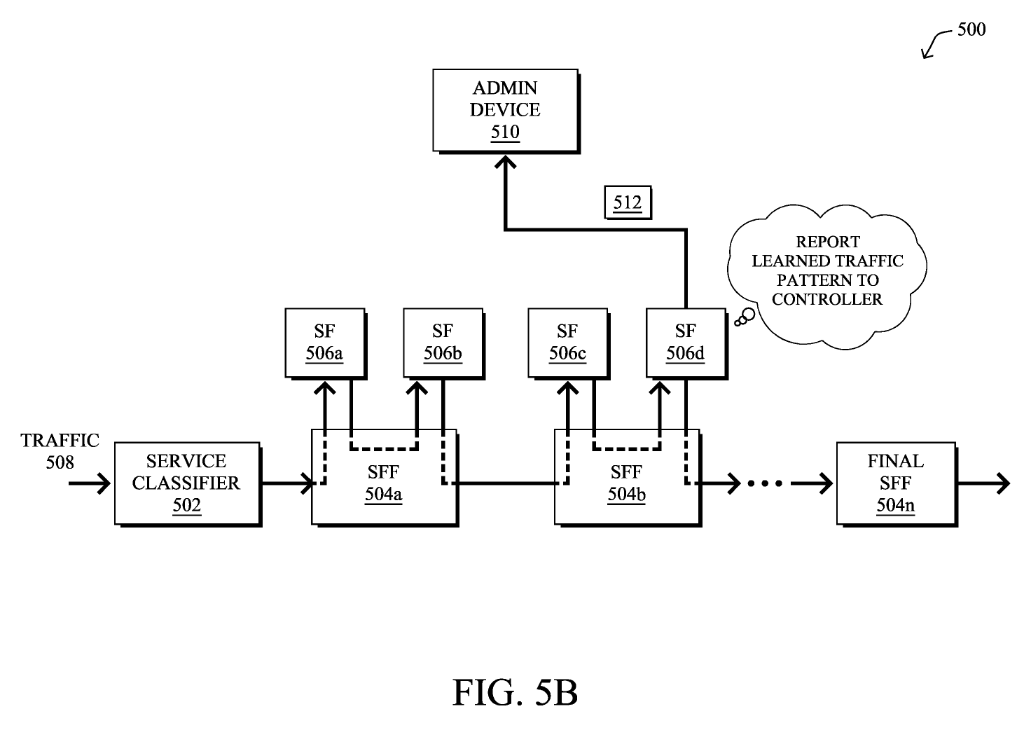

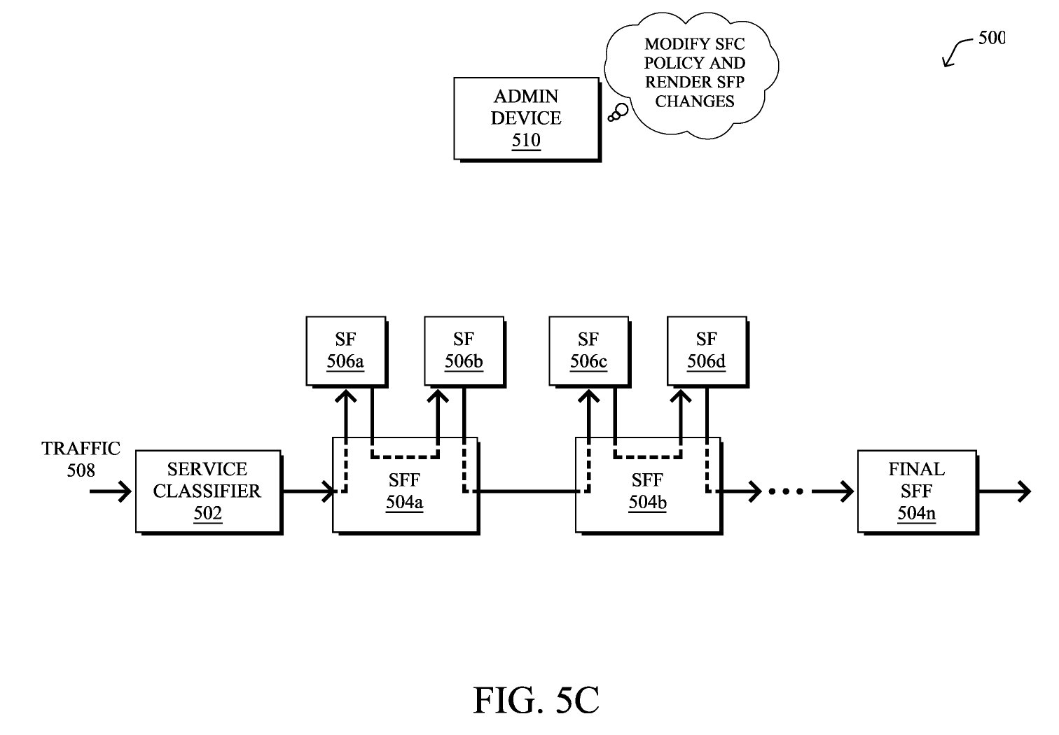

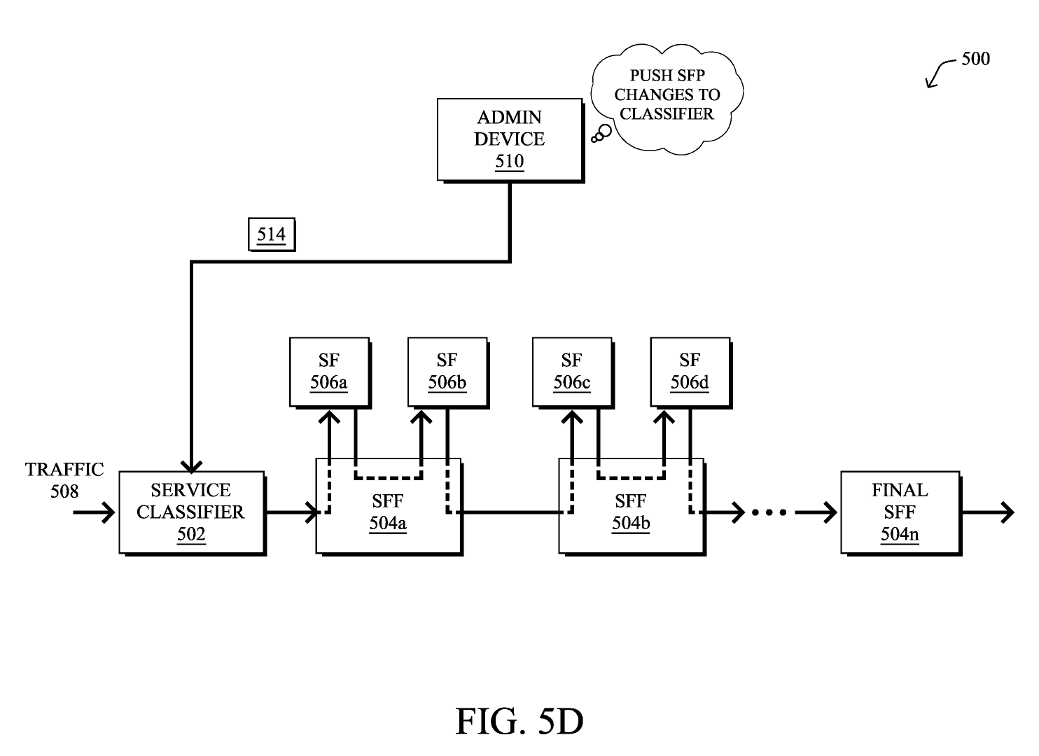

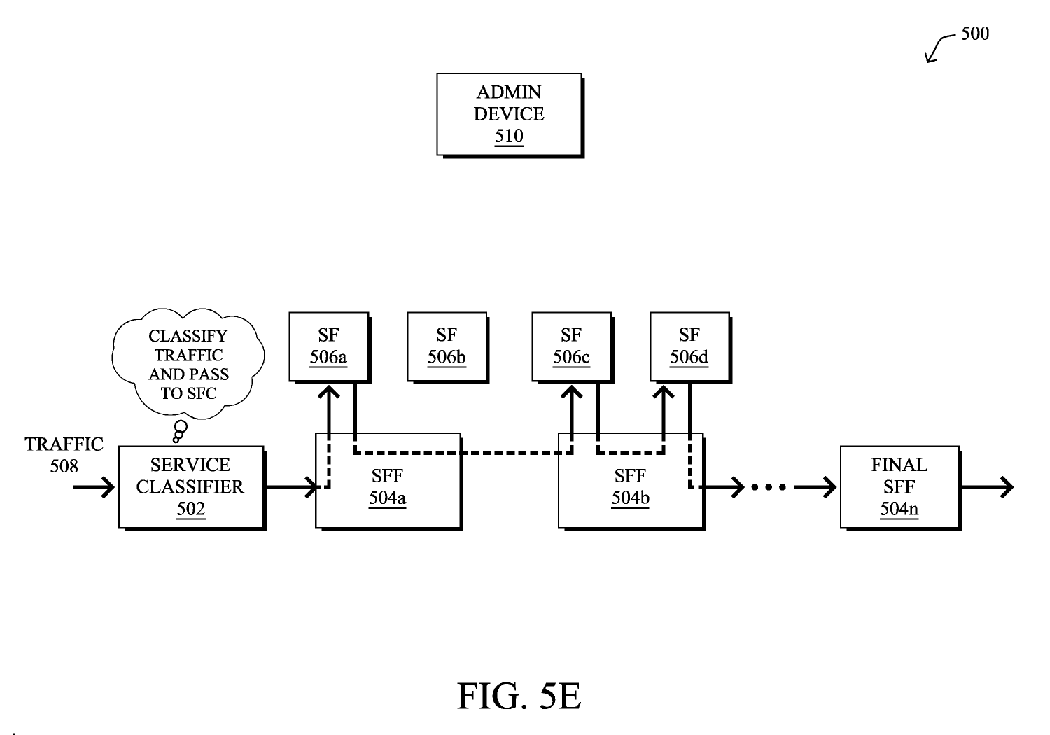

Operationally, FIGS. 5A-5E illustrate examples of using a machine learning-based service function to adjust an SFC, according to various embodiments. As shown, assume that SFC environment 500 includes a service classifier 502, n-number of SFFs 504 (e.g., SFF 504a, SFF 504b, . . . , SFF 504n, etc.), an any number of service functions (SFs) 506 associated with the various SFFs 504. Additionally, a supervisory/administrative device 510 may oversee the operations of SFC environment 500. For example, device 510 may send policy changes or instructions to a particular SF 506, may control how service classifier 508 forwards incoming traffic, and/or may control which SFs 506 are to process certain traffic in SFC environment 500.

For purpose of example, assume that incoming traffic 508 has a set of properties that are assessed and used by service classifier 502 to control the SFP traversed by traffic 508 in SFC environment 500. For example, based on the classification of traffic 508, service classifier 502 may cause traffic to be sent to SFF 504a which, in turn, causes SFs 506a and 506b to process traffic 508. Once SF 506b has finished processing traffic 508, SFF 504a may forward traffic 508 on to SFF 504b, which then applies SFs 506c and 506d to traffic 508. This process may continue on any number of times until a final SFF 504n processes traffic 508, which then leaves the SFC and continues on towards its destination in the network.

In various aspects of the techniques herein, a machine learning-based agent may be inserted into the service chain itself, to model one or more behavioral characteristics of traffic flowing through an SFC. In turn, the modeled characteristic(s) can be leveraged to make automatic changes to the SFC. For example, the agent may assess the behavioral patterns of the traffic (e.g., using logistic regression, etc.) and cause changes to be made to the SFC, accordingly.

According to various embodiments, the machine learning-based agent may itself be a service function along a given SFC or an agent in communication with one or more SFs. For example, assume that the following SFs 506 process traffic 508:
SF 506a comprises a firewall service;
SF 506b comprises a Deep Packet Inspection (DPI) service;
SF 506c comprises an Intrusion Detection or Intrusion Protection Service (IDS/IPS); and
SF 506d comprises a machine learning-based agent service that learns and models the behavioral characteristics of traffic 508.

As noted previously, SF 506d may receive traffic 508 and model the behavioral characteristics of traffic 508 using any number of different features captured from traffic 508. For example, SF 506d may assess the source and/or destinations associated with traffic 508, packet size information associated with traffic 508, timing information associated with traffic 508, the results of any prior analysis of traffic 508 by SFs 506a-506c, and the like, to learn the traffic pattern and other characteristics of traffic 508. In turn, SF 506d may identify conditions associated with the SFC and/or traffic 508 such as, but not limited to, performance issues, signs of maliciousness or attack, policy patterns, etc. For example, SF 506d may use a clustering graph or other machine learning-based mechanism to learn commonalities among the various flows of traffic 508 such as common sources, common destinations, common ports, common paths, combinations thereof, or the like.

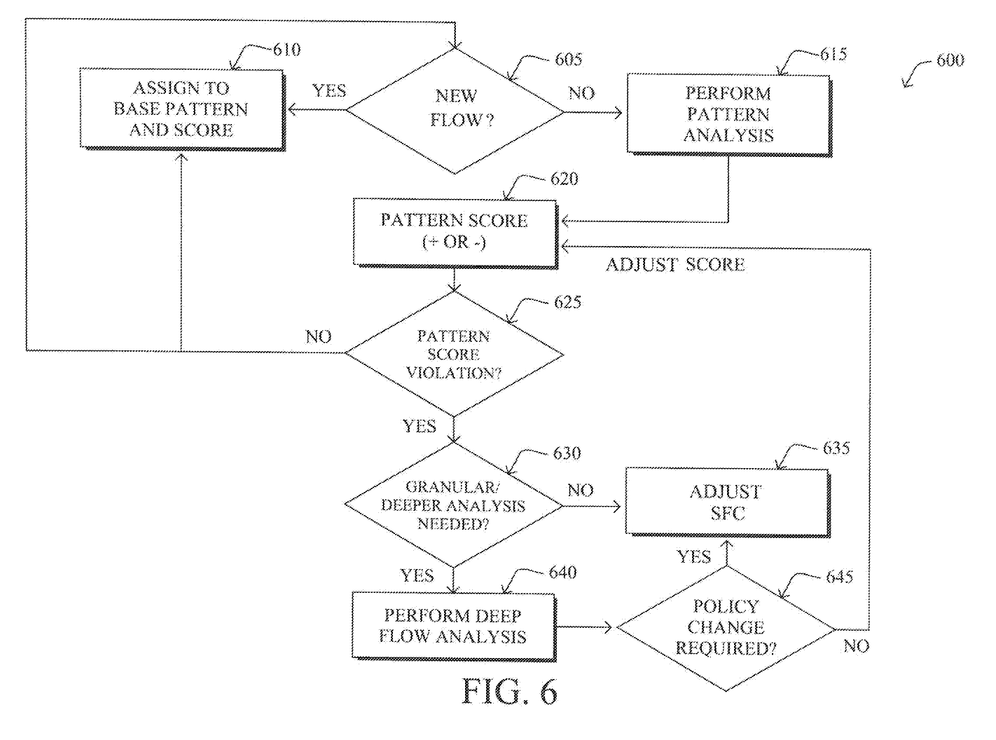

An example flow diagram 600 of one potential learning methodology for SF 306d is shown in FIG. 6, according to some embodiments. At any given point in time, SF 306d may determine whether a particular flow of traffic 508 is a new flow (block 605). If so, SF 306d may assign the flow to a base pattern and score (block 610). Otherwise, SF 506d may perform pattern analysis on the flow using the model from prior flows of traffic 508. For example, SF 506d may compare the pattern count, bitrate, protocol state (e.g., TCP state, etc.), retransmission information, duplicate information, SYN information, or the like, to the existing model of traffic 508. In some cases, SF 506d may compute a pattern score for the flow based on the pattern analysis. In turn, SF 506d may increase or decrease a pattern score based on the results of the pattern analysis on the flow (block 620). Using the computed pattern score, SF 506d may determine whether a pattern score violation has occurred (block 625). For example, if the pattern score indicates that the flow under analysis differs from that of the traffic model by a threshold amount, this may signify that the flow is anomalous/suspicious. If not, SF 506d may proceed to analyze another flow in traffic 508.

If SF 506d determines that a policy violation has occurred, SF 506d may determine whether a more granular/deeper analysis of the flow under analysis is needed (block 630). If so, SF 506d may perform a deeper analysis of the flow itself or cause another process or device to perform the analysis (block 640). If not, it may be that SF 506d has enough information about the flow to create or modify a policy for SFC environment 500 (block 635). For example, if a flow in traffic 508 is deemed anomalous, SF 506d may determine that the flow and/or related flows (e.g., having the same source, destination, etc.) should undergo DPI, be assessed by an IDS or IPS, etc. Similarly, based on the results of the deep analysis of the flow, SF 506d may determine whether a policy change is still warranted (block 645). If so, SF 506d may determine an appropriate SFC environment change (block 635). For example, based on the deeper analysis of the flow, SF 506d may determine that the flow and similar flows should be blocked by policy. Further, in some cases, the results of the deep inspection may indicate that an actual change to SFC environment 500 is not warranted, but that the computed pattern score should be adjusted, accordingly.

It should be noted that other entities may perform some or all of the functionality described with respect to FIG. 6, as well. For example, SF 506d may perform a more low-level pattern analysis on a flow and coordinate with another entity/device, such as administrative device 510, to perform a deeper analysis of the flow, as needed. Similarly, administrative device 510 may actually determine whether a change to SFC environment 500 is required, in some embodiments.

Referring again to FIGS. 5A-5E, as shown in FIG. 5B, the machine learning-based agent of SF 508d may provide an indication of the learned/modeled behavioral characteristic(s) of traffic 508 to administrative device 510 via message 512. In some embodiments, message 512 may include one or more outputs of the machine learning-based model for traffic 508, the parameters of such a model, samples of traffic 508, or any other information that administrative device 510 can use to determine whether a change to SFC environment 500 is warranted. In further embodiments, message 512 may include a recommended SFC change. For example, SF 506d may recommend a change to an existing policy, a configuration of one or more of SFs 506a-506c, which SFs 506 process traffic 508, the service chain itself (e.g., by creating new chains to solve chain-related performance degradation, etc.), or the like.

As shown in FIG. 5C, administrative device 510 may modify an SFC policy/configuration for SFC environment 500 based on the information included in message 512 from SF 506d. It is important to note that administrative device 510 may have a more global view of SFC environment 500 than that of SF 506d and may be better suited to optimize the changes based on the reaction of SFC environment 500 to a change (e.g., using loop-based feedback from SFC environment 500). Thus, even in implementations in which SF 506d suggest a change to SFC environment 500, administrative device 510 may overrule the suggested change and/or determine that a different change is needed. Further, administrative device 510 may take into account additional factors beyond just that of the modeled behaviors. For example, administrative device 510 may determine a change to SFC environment 500 based on input from a human operator, an existing service level agreement (SLA) for traffic 508, etc. As noted, a change to SFC environment 500 may be a configuration change to one or more SFs 506, a change to an SFP, a change to which SFs 506 are to process traffic 508, combinations thereof, or the like. Further, the change may apply to all of traffic 508 or a subset thereof (e.g., only flows associated with a given source, destination, port, etc.).

In FIG. 5D, for example, assume that administrative device 510 determines that traffic 508 is trusted (e.g., from a trusted source) and does not require the same level of security processing as other traffic. In turn, administrative device 510 may send an instruction 514 to service classifier 502 that adjusts which of SFs 506 are to process traffic 508.

In FIG. 5E, when a new flow of traffic 508 is received by service classifier 502, service classifier 502 may insert information into an NSH header of the flow that causes the flow to undergo processing by SF 506a and SF 506d, but not SFs 506b-506c (e.g., DPI and IDS/IPS service functions). SF 506d may also continue to monitor the flows of traffic 508, to determine whether further changes to SFC environment 500 are needed. For example, if the flows of traffic 508 begin to behave abnormally, SF 508d may cause SFs 506b-506c to again process traffic 508, accordingly.

In further implementations, the machine learning agent of SF 508d may be integrated into another SF 506, another SFF 504, or may operate in conjunction therewith to model and assess the behavioral characteristics of traffic 508. In other words, while SF 506d is described as executing the machine learning agent, the actual location of the agent in SFC environment 500 may vary, in other embodiments.

In a further use case example of the techniques herein, consider an SFC for video services that includes a video optimizer SF. Before the last SFF, there may also be a machine learning agent SF that models and assesses the video traffic flows. Assume now that there is a flood of TCP SYN packets. In such a case, the machine learning agent/SF may notify the administrative/ODL device for corrective measures to be taken. Besides TCP SYN packets, machine learning agent could also look out for any or all of the following: a TCP flow over a chain comprising a firewall SF and a NAT SF that is experiencing a retransmission rate or low window size, and/or a TCP flow to/from specific node that appears to be a large file.

In turn, the administrative device may adjust the SFC to insert a new firewall SF into the chain, to block certain flows (e.g., to prevent a SYN flood attack from occurring). For example, the administrative device may 1.) instantiate a new virtual firewall, 2.) program the firewall (e.g., to block the suspect type of traffic flows), 3.) insert the firewall into the service chain, and 4.) update the classifier, accordingly. Because the administrative/ODL device knows what the full service chain is, it can determine that the optimal action in this case is to spawn a new SF to block this type of traffic. Notably, if the same SYN flood patterns as above is detected in a service chain that is a front end to a web service, the administrative device may determine that the optimal response in this case is to insert an IDS/IPS SF into the chain. Alternatively, the optimal response may be to tunnel the suspect packets to a web security service for further security analysis.

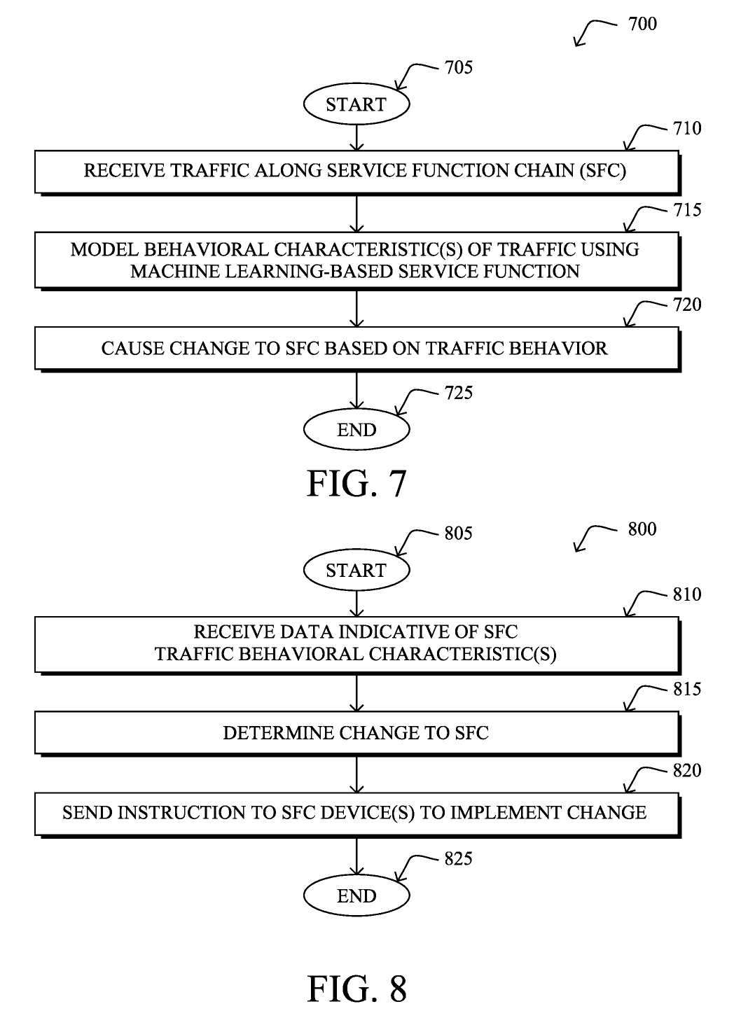

FIG. 7 illustrates an example simplified procedure for causing a change to an SFC based on a modeled behavioral characteristic of SFC traffic, in accordance with one or more embodiments described herein. For example, a non-generic, specifically configured device (e.g., device 200) may perform procedure 700 by executing stored instructions (e.g., process 248). The procedure 700 may start at step 705, and continues to step 710, where, as described in greater detail above, the device may receive traffic along a service function chain (SFC). For example, in some embodiments, the device may execute one or more service functions (SFs) or operate as a service function forwarder (SFF) along a service function chain.

At step 715, as detailed above, the device may model one or more behavioral characteristics of the traffic using a machine learning-based service function in the SFC. In some embodiments, the service function may assess any number of characteristics or statistics captured via analysis of the traffic and use this information to model the behavior of the traffic. For example, the service function may model the packet size, flow duration, protocol, etc. of the observed traffic. Such a model may also be used to determine a pattern score (e.g., a measure of how well the model fits the observed behavior of a particular flow or set of flows).

At step 720, the device may cause a change to the SFC based on the modeled one or more behavioral characteristics of the traffic, as described in greater detail above. In some embodiments, the device may itself determine and provide a recommended change to the SFC to an administrative/supervisory device. In further embodiments, the device may provide an indication of the modeled one or more behavioral characteristics to the supervisory device. For example, if a particular traffic flow or set of traffic flows do not exhibit an expected behavior from the machine learning-based model, a corresponding change to the SFC may be made (e.g., by adding or removing an SF along the chain, changing a configuration of a particular SF, etc.). Procedure 700 then ends at step 725.

FIG. 8 illustrates an example simplified procedure for implementing a change to an SFC, in accordance with one or more embodiments herein. Procedure 800 may be performed by a supervisory device in an SFC environment, such as an administrative/ODL device in the network. Procedure 800 may start at step 805 and continues on to step 810 where, as described in greater detail above, the supervisory device may receive data indicative of one or more behavioral characteristics of traffic in the SFC. In some embodiments, the indication may be provided by a machine learning-based service function or other agent in the SFC that observers and models the behavioral characteristics of the SFC traffic. In some cases, the indication may include data regarding the actual one or more behavioral characteristics themselves. In further cases, the indication may comprise a recommended change to the SFC based on the behavior. For example, if a certain traffic flow or set of traffic flows exhibits a particular behavior, the indication may include a recommendation that the supervisory device modify the SFC to require that these flows undergo greater scrutiny.

At step 815, as detailed above, the supervisory device may determine a change to the SFC based on the received data. In cases in which the received data includes a recommendation, the supervisory device may verify that the recommended change would be in accordance with an existing network policy (e.g., an SLA for the traffic flows, etc.). In further cases, the device may receive input from a user interface regarding the change to the SFC. In yet another embodiment, the supervisory device may apply its own machine learning and/or a feedback mechanism, to determine the optimal change to the SFC based on the traffic behavior. Example changes to the SFC may include, but are not limited to, a change to a configuration of a particular service function in the SFC that processes the traffic, a change to how the traffic is forwarded in the SFC, or a change to which service functions in the SFC process the traffic.

At step 820, the supervisory device may send an instruction to one or more devices of the SFC, to implement the determined change from step 815, as described in greater detail above. For example, one instruction may be sent to a service classifier to cause the traffic to be sent via a different service chain or path. In another example, another instruction may be sent to a device to instantiate a virtual SF that is to process the traffic. In a further example, an instruction may change the configuration of an existing SF (e.g., by causing a firewall SF to block certain flows, etc.). Procedure 800 then ends at step 825.

It should be noted that while certain steps within procedures 700-800 may be optional as described above, the steps shown in FIGS. 7-8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 700-800 are described separately, certain steps from each procedure may be incorporated into each other procedure, and the procedures are not meant to be mutually exclusive.

The techniques described herein, therefore, allow for the automatic and continuous enforcement of service chain and/or policy changes in an SFC environment. By observing and modeling the behavior of SFC traffic in-line using a machine learning-based process/service, the techniques herein allow for the system to automatically adapt to new potential threats, performance changes, and other conditions.

While there have been shown and described illustrative embodiments that provide for using behavioral analytics to automatically change an SFC environment, it is to be understood that various other adaptations and modifications may be made within the spirit and scope of the embodiments herein. For example, while certain embodiments are described herein with respect to using certain models for purposes of modeling traffic behavior, the models are not limited as such and may be used for other functions, in other embodiments. In addition, while certain protocols are shown, such as BGP, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving, at a device in a network, traffic sent via a service function chain (SFC);
modeling, by the device, one or more behavioral characteristics of the traffic using a machine learning-based service function in the SFC; and
causing, by the device, a change to the SFC based on the modeled one or more behavioral characteristics of the traffic.

2. The method as in claim 1, wherein causing the change to the SFC based on the modeled one or more behavioral characteristics of the traffic comprises:
providing, by the device, a recommended SFC change to a supervisory device of the SFC, wherein the supervisory device implements the change to the SFC based on the recommended SFC change.

3. The method as in claim 1, wherein the change to the SFC comprises at least one of: a change to a configuration of a particular service function in the SFC that processes the traffic, a change to how the traffic is forwarded in the SFC, or a change to which service functions in the SFC process the traffic.

4. The method as in claim 1, wherein the one or more behavioral characteristics of the traffic identify a source or destination associated with the traffic as trusted.

5. The method as in claim 1, wherein the change to the SFC causes the traffic to be processed by a service function in the SFC that comprises at least one of: a firewall, an intrusion detection system (IDS), or an intrusion protection system (IPS).

6. The method as in claim 1, wherein the change to the SFC is based further in part on a service level agreement (SLA) associated with the traffic.

7. The method as in claim 1, wherein the one or more behavioral characteristics of the traffic is indicative of a performance degradation of the SFC.

8. A method comprising:
receiving, at a supervisory device of a service function chain (SFC) in a network, data indicative of one or more behavioral characteristics of traffic in the SFC from a machine learning-based service function in the SFC that analyzes the traffic;
determining, by the supervisory device, a change to the SFC based on the received data indicative of the one or more behavioral characteristics of the traffic in the SFC; and
sending, by the supervisory device, an instruction to one or more devices of the SFC to implement the determined change to the SFC.

9. The method as in claim 8, wherein the change to the SFC comprises at least one of: a change to a configuration of a particular service function in the SFC that processes the traffic, a change to how the traffic is forwarded in the SFC, or a change to which service functions in the SFC process the traffic.

10. The method as in claim 8, wherein the one or more behavioral characteristics of the traffic identify a source or destination associated with the traffic as trusted.

11. The method as in claim 8, wherein the change to the SFC causes the traffic to be processed by a service function in the SFC that comprises at least one of: a firewall, an intrusion detection system (IDS), or an intrusion protection system (IPS).

12. The method as in claim 8, wherein the data indicative of the one or more behavioral characteristics of traffic in the SFC comprises a recommended change to the SFC from the machine learning-based service function.

13. The method as in claim 8, wherein the one or more behavioral characteristics of the traffic is indicative of a performance degradation of the SFC.

14. An apparatus, comprising:
one or more network interfaces to communicate with a network;
a processor coupled to the network interfaces and configured to execute one or more processes; and
a memory configured to store a process executable by the processor, the process when executed operable to:
receive traffic sent via a service function chain (SFC);
model one or more behavioral characteristics of the traffic using a machine learning-based service function in the SFC; and
cause a change to the SFC based on the modeled one or more behavioral characteristics of the traffic.

15. The apparatus as in claim 14, wherein the apparatus causes the change to the SFC based on the modeled one or more behavioral characteristics of the traffic by:
providing a recommended SFC change to a supervisory device of the SFC, wherein the supervisory device implements the change to the SFC based on the recommended SFC change.

16. The apparatus as in claim 14, wherein the change to the SFC comprises at least one of: a change to a configuration of a particular service function in the SFC that processes the traffic, a change to how the traffic is forwarded in the SFC, or a change to which service functions in the SFC process the traffic.

17. The apparatus as in claim 14, wherein the one or more behavioral characteristics of the traffic identify a source or destination associated with the traffic as trusted.

18. The apparatus as in claim 14, wherein the change to the SFC causes the traffic to be processed by a service function in the SFC that comprises at least one of: a firewall, an intrusion detection system (IDS), or an intrusion protection system (IPS).

19. The apparatus as in claim 14, wherein the change to the SFC is based further in part on a service level agreement (SLA) associated with the traffic.

20. The apparatus as in claim 14, wherein the one or more behavioral characteristics of the traffic is indicative of a performance degradation of the SFC.
